(19) United States
(12) Patent Application Publication
(10) Pub. No.: US 2007/0097026 A1
(43) Pub. Date: May 3, 2007

(54) Plasma display apparatus

(75) Inventor: Seonghak Moon, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/588,215

(22) Filed: Oct. 27, 2006

(30) Foreign Application Priority Data
Oct. 28, 2005 (KR) 10-2005-0102634

(51) Int. Cl. G09G 3/28

(52) U.S. Cl. 345/60

(57) ABSTRACT

A plasma display apparatus is disclosed. The plasma display apparatus includes a sensor and a controller. The sensor detects an ambient luminance of a plasma display panel. The controller controls at least one of a voltage of driving signal and the number of driving signals for driving the plasma display panel in accordance with the ambient luminance.

This Nonprovisional application claims priority under 35 U.S.C. § 119(a) on Patent Application No. 10-2005-0102634 filed in Korea on Oct. 28, 2005 the entire contents of which are hereby incorporated by reference.

### BACKGROUND

1. Field

This document relates to a plasma display apparatus.

2. Description of the Background Art

A plasma display panel includes barrier ribs formed between a front substrate and a rear substrate. Together, the barrier ribs and the front and rear substrates from cells. Each of the cells is filled with a primary discharge gas such as neon (Ne), helium (He) or a mixed gas comprising Ne and He. In addition, each cell contains an inert gas comprising a small amount of xenon.

If the inert gas is discharged using a high frequency voltage, ultraviolet rays are generated. The ultra-violet rays, which are invisible to the human eye, excite light-emitting phosphors in each cell, thus creating a visible image. Plasma display panels can be made thin and slim, and thus have been in the spotlight as the next-generation of display devices.

### SUMMARY

It is an object of the present invention to provide a plasma display apparatus that can improve a characteristic of contrast when a plasma display panel is driven.

Another object of the present invention is to provide a plasma display apparatus that can decrease power consumption when a plasma display panel is driven.

In one aspect, there is provided a plasma display apparatus containing a sensor for detecting an ambient luminance of a plasma display panel and a controller for controlling at least one of a voltage of driving signal and the number of driving signals for driving the plasma display panel in accordance with the ambient luminance.

Implementations may include one or more of the following features. For example, at least one of the voltage of driving signal and the number of driving signals when the ambient luminance is equal to or more than a reference luminance may be more than at least one of the voltage of driving signal and the number of driving signals when the ambient luminance equals an average ambient luminance.

At least one of the voltage of driving signal and the number of driving signals when the ambient luminance is less than a reference luminance, may be less than at least one of the voltage of driving signal and the number of driving signals when the ambient luminance equals an average ambient luminance.

The driving signal may be a reset signal applied to an electrode of the plasma display panel during a reset period.

The driving signal may be a sustain signal applied to an electrode of the plasma display panel during a sustain period.

At least one of the voltage of driving signal and the number of driving signal may be controlled in at least one of a plurality of subfields.

In another aspect, there is provided a plasma display apparatus containing a detector for detecting a movement of a subject in a plasma display panel surroundings and a controller for converting an image mode into a suspend mode so that an image is not displayed on the plasma display panel, when the subject does not move during a duration of a first reference time.

Implementations may include one or more of the following features. For example, a movement of a subject may be a difference of a first gray value of the subject and a second gray value of the subject in the same position of the plasma display panel surroundings, or an amount of vector of the movement of subject.

The controller may convert an image mode into a standby mode, when the subject does not move during a duration of a second reference time.

The suspend mode may be a mode in which a data signal is not applied to an electrode of the plasma display panel during an address period.

The suspend mode may be a mode in which a sustain signal is not applied to an electrode of the plasma display panel during a sustain period.

The detector may include a camera for taking a photograph of the subject.

The camera may include an image memory for storing an image of the subject.

The detector may be formed on a non-display area of the plasma display panel and the number of detectors is plural.

In still another aspect, there is provided a plasma display apparatus containing a detector for detecting a movement of a subject in a plasma display panel surroundings and a controller for converting an image mode into a standby mode so that an image is not displayed on the plasma display panel, when the subject does not move during a duration of a first reference time.

Implementations may include one or more of the following features. For example, a standby mode may be a mode in which an image is displayed when the subject moves.

The standby mode may be a mode in which a data signal is not applied to an electrode of the plasma display panel during an address period.

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 is a conceptual view illustrating a structure of a plasma display apparatus;

FIG. 2 illustrates a configuration of a plasma display panel;

FIG. 3 illustrates a method of driving a plasma display panel of FIG. 1;

FIG. 4 illustrates a method driving the plasma display apparatus in accordance with an ambient luminance of the plasma display panel;

FIG. 5 illustrates a position where a sensor formed in the plasma display apparatus;

FIG. 6 is a block diagram schematically illustrating the configuration of a plasma display apparatus according to an embodiment of the present invention; and

FIG. 7 illustrates a method of driving the plasma display apparatus according to a movement of subject in the plasma display panel surroundings.

### DETAILED DESCRIPTION OF PREFERRED EMBODIMENTS

Preferred embodiments of the present invention will be described in a more detailed manner with reference to the drawings.

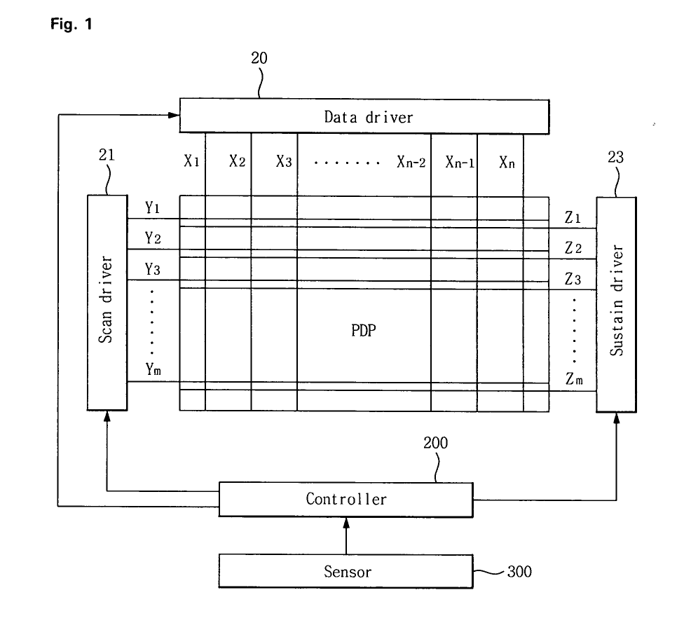

FIG. 1 illustrates a plasma display apparatus according to a first embodiment of the present invention.

Referring to FIG. 1, the plasma display apparatus includes a plasma display panel PDP which is displayed an image thereon, a plurality of drivers containing a data driver 20, a scan driver 21 and a sustain driver 23 which apply a driving signal to a plurality of electrodes of the plasma display panel, a sensor 300 which detects an ambient luminance in the plasma display panel surroundings, and a controller 200 which controls the plurality of drivers 20, 21, 23 to control a brightness of the image displayed on the plasma display panel in accordance with a signal of the ambient luminance provided from the sensor 300.

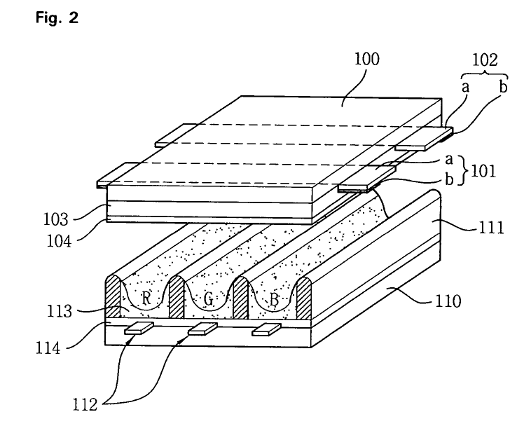

FIG. 2 is a perspective view showing the plasma display panel of FIG. 1,

As shown in FIG. 2, the plasma display panel includes a front substrate 100 that serves as the display surface on which the images are displayed, and a rear substrate 110 forming a rear surface. The front substrate 100 and the rear substrate 110 are parallel to each other, with a predetermined distance therebetween.

The front substrate 100 includes a scan electrode 101 (Y electrode) and a sustain electrode 102 (Z electrode), both of which are employed in controlling the discharge and light emission of the discharge cell shown in FIG. 2. The Y electrode 101 and the Z electrode 102 each have a transparent electrode “a” made of a transparent ITO material, and a bus electrode “b” made of a metal material. The Y electrode 101 and the Z electrode 102 together form an electrode pair. The Y electrode 101 and the Z electrode 102 are covered with at least one dielectric layer 103 for limiting a discharge current and for providing insulation. A protection layer 104, having magnesium oxide (MgO) deposited thereon to facilitate a discharge condition, is formed on the dielectric layer 103.

In the rear substrate 110, barrier ribs 111 in the form of a stripe pattern (or well type), for forming a plurality of discharge spaces, i.e., discharge cells, are arranged in a parallel manner. Further, a plurality of address electrodes 112 (X electrodes) for use in achieving an address discharge which, in turn, results in the generation of ultraviolet light, is disposed parallel to the barrier ribs 111. Red (R), green (G) and blue (B) phosphors 113, for emitting visible light for image display upon address discharge, are coated on a top surface of the rear substrate 110. A white dielectric layer 114, which protects the address electrodes 112 and reflects the visible light emitted from the phosphors 113 to the front substrate 100, is formed generally between the address electrodes 112 and the phosphors 113.

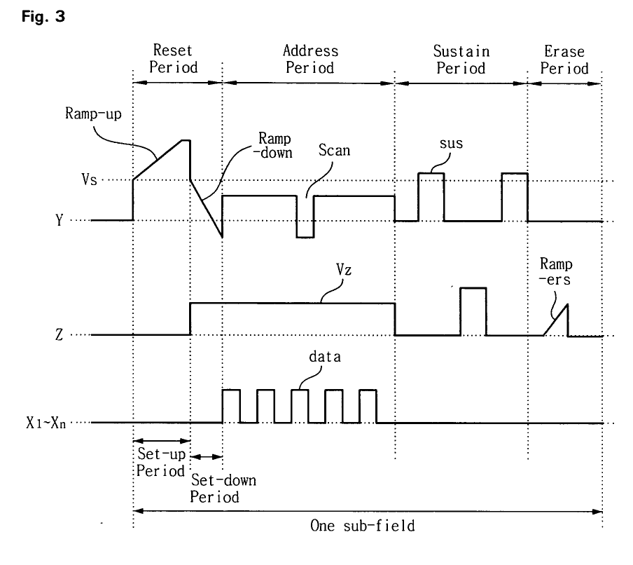

The plasma display panel is driven by applying a driving signal to a plurality of electrodes of the plasma display panel such as the scan electrode 101, the sustain electrode 102 and the data electrode 112 as shown in FIG. 3.

FIG. 3 illustrates a driving signal that is used in a method of driving the plasma display panel of FIG. 1.

As shown, during a given sub-field, the waveforms associated with the X, Y and Z electrodes are divided into a reset period for initializing all cell, an address period for selecting cells that are to be discharged, a sustain period for maintaining discharging of selected cells, and an erase period for erasing wall charges within each of the discharge cells.

During a set-up period of the reset period, a ramp-up waveform (Ramp-up) is applied to all of the Y electrodes at the same time. As a result, weak dark discharge is generated in all of the discharge cells for the entire screen. It will be understood that the term “dark discharge” refers to a discharge within a given cell that results in little or no visible light emission. The set-up discharge causes wall charges of a positive polarity to be accumulated at the X electrodes and the Z electrodes, and wall charges of a negative polarity to accumulate at the Y electrodes, where the Z electrodes refer to the sustain electrodes.

During a set-down period, after the ramp-up waveform is supplied, a ramp-down waveform (Ramp-down), which falls from a positive polarity voltage lower than the peak voltage of the ramp-up waveform, to a given voltage lower than a ground GND level voltage. The ramp-down waveform causes a weak erase discharge to occur in all of the cells. Therefore, excessive wall charges formed on the Y electrodes are sufficiently erased. The set-down discharge also optimizes the wall charges for the address period, such than an address discharge can be generated stably within the appropriate cells.

During the address period, while a negative scan signal (Scan) is sequentially applied to the Y electrodes, a positive data signal is applied to the X electrodes in synchronism with the scan signal. As a result of the voltage difference between the scan signal and the data signal, as well as the wall voltage generated during the reset period, an address discharge is generated within those discharge cells to which a data signal is applied. Furthermore, wall charges, sufficient for generating a discharge when a sustain voltage Vs is applied, are formed within cells selected by the address discharge. A positive polarity voltage Vz is applied to the Z electrodes so that erroneous discharge does not occur with the Y electrode by reducing the voltage difference between the Z electrode and the Y electrode during the set-down period and the address period.

During the sustain period, a sustain signal (Sus) is alternately applied to the Y electrodes and the Z electrodes. In cells selected during the address period, a sustain discharge, i.e., a display discharge, is generated between the Y electrodes and the Z electrodes whenever the sustain signal is applied.

After the sustain period is completed, there is an erase period, during which a voltage associated with an erase ramp waveform (Ramp-ers), which has a small pulse width and a low voltage level, is applied to the Z electrodes, so that wall charges remaining within all of the cells are erased.

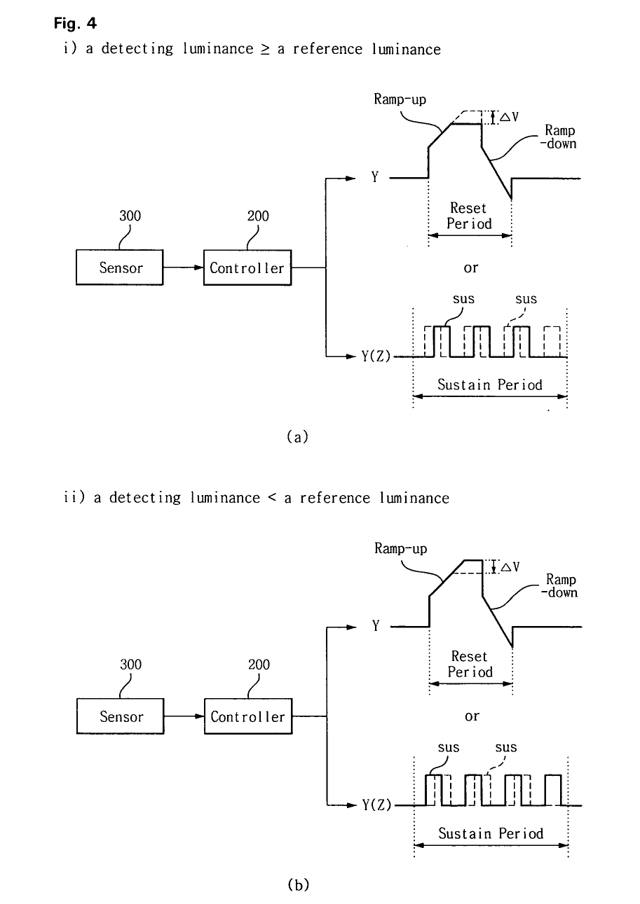

FIG. 4 illustrates a method driving the plasma display apparatus in accordance with an ambient luminance of the plasma display panel in the first embodiment of the present invention.

Referring to FIG. 4, in the first embodiment, the sensor 300 detects an ambient luminance of the plasma display panel and compares a detecting ambient luminance level with a reference luminance level and the controller 200 controls a voltage of driving signal applied to an electrode of the plasma display panel or controls the number of driving signals applied to the electrode of the plasma display panel in accordance with the detecting ambient luminance level of the plasma display panel provided from the sensor 300.

The driving signal may be the whole of driving signal which is applied to the electrodes of the plasma display panel to generate a discharge in the discharge cells during each period such as the reset period, the address period, and the sustain period when the plasma display panel is driven.

Preferably, the driving signal may be the reset signal applied to the scan electrode during the reset period or the sustain signal applied alternately to the scan electrode or the sustain electrode during the sustain period.

As illustrated in (a), when the detecting ambient luminance level of the plasma display panel is equal to or more than a reference luminance level, the controller 200 controls a maximum voltage of reset signal to be more than the fixed maximum voltage of reset signal applied to the scan electrode Y when the detecting ambient luminance level equals an average ambient luminance level. That is, the maximum voltage of the reset signal increases from the set-up voltage (Vsetup) to the set-up voltage added a predetermined voltage (ΔV).

The average ambient luminance level is a value that is averaging the detecting luminance levels in the plasma display panel surroundings when the plasma display panel is driven for a duration of a predetermined time.

The reset signal which is applied to the scan electrode Y has the ramp-up waveform (Ramp-up) and the ramp-down waveform (Ramp-down)

Further, when the ambient luminance level of the plasma display panel is equal to or more than the reference luminance level, the controller 200 controls the number of sustain signals to be more than the fixed number of sustain signals applied to the scan electrode Y or the sustain electrode Z when the detecting ambient luminance level equals the average ambient luminance level.

As illustrated in (b), when the detecting ambient luminance level of the plasma display panel is less than a reference luminance level, the controller 200 controls a maximum voltage of reset signal to be less than the fixed maximum voltage of reset signal applied to the scan electrode Y when the detecting ambient luminance level equals an average ambient luminance level. That is, the maximum voltage of the reset signal decreases from the set-up voltage (Vsetup) to the set-up voltage drawn a predetermined voltage (ΔV).

Further, when the ambient luminance level of the plasma display panel is less than the reference luminance level, the controller 200 controls the number of sustain signals to be less than the fixed number of sustain signals applied to the scan electrode Y or the sustain electrode Z when the detecting ambient luminance level equals the average ambient luminance level.

At least one of the maximum voltage of the reset signal and the number of sustain signals may be controlled in the whole of subfields within a frame or may be controlled in at least one subfield of the whole of subfields within a frame when the plasma display panel is driven.

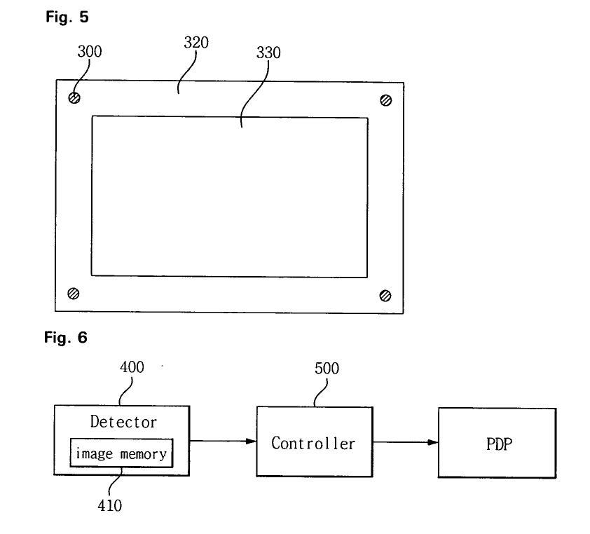

FIG. 5 illustrates a position where a sensor formed in the plasma display apparatus.

Referring to FIG. 5, the whole area of the plasma display apparatus is divided into a display area 330 on which an image is displayed and a non-display area 320 on which the image is not displayed.

The sensor 300 is positioned on the non-display area 320 of the plasma display apparatus. Preferably, the sensor 300 may be positioned on a portion of the corner of the non-display area 320.

Further, the non-display area 320 may be a portion of a case, which covers the plasma display panel, to protect the plasma display panel from an outer shock.

The number of sensors may be single or plural.

As described above, the plasma display apparatus improve a characteristic of contrast by controlling the voltage of the driving signal or the number of driving signals in accordance with the ambient luminance of the plasma display panel.

FIG. 6 is a block diagram of a plasma display apparatus according to a second embodiment of the present invention.

Referring to FIG. 6, in the second embodiment, the plasma display apparatus includes the plasma display panel PDP which is displayed an image thereon, a detector 400 which detects a movement of a subject in the plasma display panel surroundings, and a controller 500 which controls the image displayed on the plasma display panel in accordance with the movement of the subject.

Since a structure of the plasma display panel is the same as the structure of the plasma display panel described in the first embodiment, a description thereof is omitted.

Further, since the method of driving the plasma display panel is the same as the method of driving the plasma display panel described in the first embodiment, a description is omitted.

As described in first embodiment, the detector 400 also is positioned on the non-display area of plasma display apparatus and preferably may be positioned on a portion of the corner of the non-display area.

The detector 400 may include a camera for taking a photograph of the subject and the number of cameras may be plural.

Each of the cameras may include an image memory 410 to store an image of the subject.

In this case, an area in which the camera can detect may be controlled by operating a remote controller. (not shown) that is, the remote controller controls the detecting area of the each camera so that each of cameras can take a photograph of the subject in various direction of the subject.

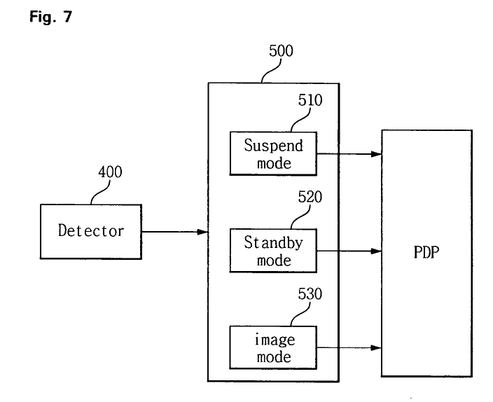

FIG. 7 illustrates a method of driving the plasma display apparatus according to a movement of subject in the plasma display panel surroundings in the second embodiment.

As illustrated in FIG. 7, the detector 400 detects the movement of the subject in the plasma display panel surroundings and provides a detecting signal of the subject to the controller 200 and the controller 200 controls an image displayed on the plasma display panel to be converted a predetermined mode in accordance with the detecting signal from the detector 400.

The detector 400 detects whether the subject moves or not and checks a duration of time of the movement of the subject when the subject moves.

The controller 500 controls an image screen of the plasma display panel to be converted an image mode 530 when the subject moves, and controls the image screen of the plasma display panel to be converted suspend mode 510 when the subject does not move during a duration of a first reference time.

The suspend mode 510 is a mode in which is not displayed on the plasma display panel.

In suspend mode, although the plasma display apparatus processes an image data (i.e., R, G, B, and Y, U, V), the plasma display apparatus is not applied a data signal or a sustain signal to the electrodes of the plasma display panel.

Further, the suspend mode 510 may be converted into a standby mode 520 when the subject does not move during a duration of a second reference time more than the duration of a first reference time.

The standby mode 520 is a mode in which a minimum voltage applied to the plasma display apparatus to be displayed an image on the plasma display panel when the subject moves. In this case, the standby mode 520 is a mode which at least one signal of the data signal and the sustain signal also is not applied to the electrodes of the plasma display panel.

The detector 400 may define the movement of the subject by using a gray value of the subject or a vector value of the subject.

For example, the movement of the subject may be defined by a difference of a first gray value of the subject and a second gray value of the subject. The first gray value is that detects a gray value of the subject at first time in given position of the plasma display panel surroundings and the second gray value is that detects a gray value of the subject at second time after the first time in the same position of the plasma display panel surroundings,

The vector value of the subject is a direction value and a magnitude value of the movement of the subject in the given position of the plasma display panel surroundings.

As described above, the plasma display apparatus decreases a power consumption by converting the image screen into the image mode or the suspend mode in accordance with the movement of the subject in the plasma display panel surroundings and displays an image which is taken a picture of the subject on the plasma display panel.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus, comprising;
a sensor for detecting an ambient luminance of a plasma display panel; and
a controller for controlling at least one of a voltage of driving signal and the number of driving signals for driving the plasma display panel in accordance with the ambient luminance.

2. The plasma display apparatus of claim 1, wherein at least one of the voltage of driving signal and the number of driving signals when the ambient luminance is equal to or more than a reference luminance, is more than at least one of a fixed voltage of driving signal and the fixed number of driving signals when the ambient luminance equals an average ambient luminance of the plasma display panel.

3. The plasma display apparatus of claim 1, wherein at least one of the voltage of driving signal and the number of driving signals when the ambient luminance is less than a reference luminance, is less than at least one of the fixed voltage of driving signal and the fixed number of driving signals when the ambient luminance equals an average ambient luminance of the plasma display panel.

4. The plasma display apparatus of claim 1, wherein the driving signal is a reset signal applied to an electrode of the plasma display panel during a reset period.

5. The plasma display apparatus of claim 1, wherein the driving signal is a sustain signal applied to an electrode of the plasma display panel during a sustain period.

6. The plasma display apparatus of claim 1, wherein at least one of the voltage of driving signal and the number of driving signal are controlled in at least one subfield of a plurality of subfields.

7. The plasma display apparatus of claim 1, wherein the number of sensors is plural.

8. The plasma display apparatus of claim 1, wherein the sensor is formed on a non-display area of the plasma display panel.

9. A plasma display apparatus, comprising:
a detector for detecting a movement of a subject in a plasma display panel surroundings; and
a controller for converting an image mode into a suspend mode so that an image is not displayed on the plasma display panel, when the subject does not move during a duration of a first reference time.

10. The plasma display apparatus of claim 9, wherein the movement of a subject is a difference of a first gray value of the subject and a second gray value of the subject in the same position of the plasma display panel surroundings, or a vector of the movement of subject.

11. The plasma display apparatus of claim 9, wherein the controller converts an image mode into a standby mode, when the subject does not move during a duration of a second reference time.

12. The plasma display apparatus of claim 9, wherein the suspend mode is a mode in which a data signal is not applied to an electrode of the plasma display panel during an address period.

13. The plasma display apparatus of claim 9, wherein the suspend mode is a mode in which a sustain signal is not applied to an electrode of the plasma display panel during a sustain period.

14. The plasma display apparatus of claim 9, wherein the detector includes a camera for taking a photograph of the subject.

15. The plasma display apparatus of claim 14, wherein the camera includes an image memory for storing an image of the subject.

16. The plasma display apparatus of claim 9, wherein the detector is formed on a non-display area of the plasma display panel and the number of detectors is plural.

17. A plasma display apparatus, comprising:
a detector for detecting a movement of a subject in a plasma display panel surroundings; and
a controller for converting an image mode into a standby mode so that an image is not displayed on the plasma display panel, when the subject does not move during a duration of a first reference time.

18. The plasma display apparatus of claim 17, wherein the standby mode is a mode in which an image is displayed when the subject moves.

19. The plasma display apparatus of claim 17, wherein the standby mode is a mode in which a data signal is not applied to an electrode of the plasma display panel during an address period.

20. The plasma display apparatus of claim 17, wherein the detector is formed on a non-display area of the plasma display panel and the number of detectors is plural.
